(19) United States
(12) Patent Application Publication
(10) Pub. No.: US 2012/0060196 A1
(43) Pub. Date: Mar. 8, 2012

(54) MACHANISM OF INTERLEAVING VIDEO FRAME STORAGE FOR P2P-BASED VOD STREAMING SYSTEM

(76) Inventors: Ching-Lung Chang, Touliu (TW); Ssu-Ping Huang, Touliu (TW)

(21) Appl. No.: 12/874,483

(22) Filed: Sep. 2, 2010

(51) Int. Cl. H04N 7/173

(52) U.S. Cl. 725/93

(57) ABSTRACT

The Mechanism of Interleaving Video Frame Storage for P2P-based VoD Streaming System offers a storing means to interleaved frames in a peer-to-peer structure. Video frames in each frame group saved in a server unit are numbered. Frame data in each frame group with the same number are accordingly sorted into one group, thence forming the interleaved frame group. By pre-loading, each afore interleaved frame group is saved in divergent peer nodes beforehand. The peer nodes are set at either a receiving end or a supplying end. Logining in the system of the present invention for selecting a video, users further link to the supplying end of each interleaved frame group, where the correspondent video frames would be streamingly transmitted to users, thereby providing the video player with a facile operation. The ready-to-play time after operating the video player is preferably shortened.

### BACKGROUND OF THE INVENTION

1. Field of the Invention

The present invention relates to mechanism of interleaving video frame storage for P2P-based VOD streaming system.

2. Description of the Related Art

With the daily developed Internet technology, the peer-to-peer video on demand (VOD) stream system has become a popular subject. The increment of the video cassette recorder (VCR) function into the peer-to-peer VOD stream system is also soaring recently. In the VOD stream system, how a server distributively stores one video into the respective peer nodes would relatively influence the playing effect, especially influencing the ready-to-play or reading time between the initial video operation and the ensued playing action. Herein, the existing VOD stream system with the video player function in light of the peer-to-peer scheme mainly utilizes the following storing means to share the frames:

1. The peer nodes previously save the received frames in a playback buffer. After playing, the frames would be deleted. Moreover, the peer nodes share the frames saved in the playback buffer with other peer nodes. Such storing means and sharing mechanism of the frames are called “Cache and Relay”. By means of afore means and mechanism, accessible frames between the peer nodes are likely varied in view of the passing time and the inconstant operation of the video player.

2. The server applied to the VOD stream system evenly divides a complete video into multiple segments in advance. Herein, the video frame of each segment is directed to the sequential frame. Whereby, these segments would be distributively saved to the peer nodes. Consequently, besides a space for the playback buffer, the peer nodes have to reserve an extra space for storing the respective segments. The peer nodes substantially share their stored segments to other peer nodes, and such specific proceeding is concluded as “Pre-load”.

### SUMMARY OF THE INVENTION

The object of the present invention is to provide a peer-to-peer structure for submitting a storing means to interleaved frames. That is, video frames in a group of pictures (GOP) of the videos would be numbered, and the video frames with the same number in each GOP would be classified into the same group. Herein, the frames in one group are not arranged in sequence, and the classified group is directed to an “interleaved frame group”. Concurrently, adopting the pre-loading mechanism, afore video frames in the respective interleaved frame groups could be previously saved to each peer node. Thereby, the peer nodes are set at either a receiving end or a supplying end. Accordingly, if a user (the peer nodes at the receiving end) logins in the system in accordance with the present invention and would like to select a video, the user needs to connect the peer nodes at the supplying end of each interleaved frame group. As a result, the peer nodes at the supplying end would streamingly transmit the video frames stored in their interleaved frame groups to the user, so that the ready-to-play time after operating the video player could be shortened.

### BRIEF DESCRIPTION OF THE DRAWINGS

FIG. 1 is a schematic view showing a mechanism of interleaving video frame storage for P2P-based VOD streaming system of the present invention in a linking state;

FIG. 2 is a schematic view showing the interleaved frame groups in a distributive state;

FIG. 3 is a schematic view showing the interleaved frame groups being transmitted to peer nodes at a receiving end; and

FIG. 4 is a schematic view showing an overlay structure of the present invention in a linking state.

### DETAILED DESCRIPTION OF THE PREFERRED EMBODIMENTS

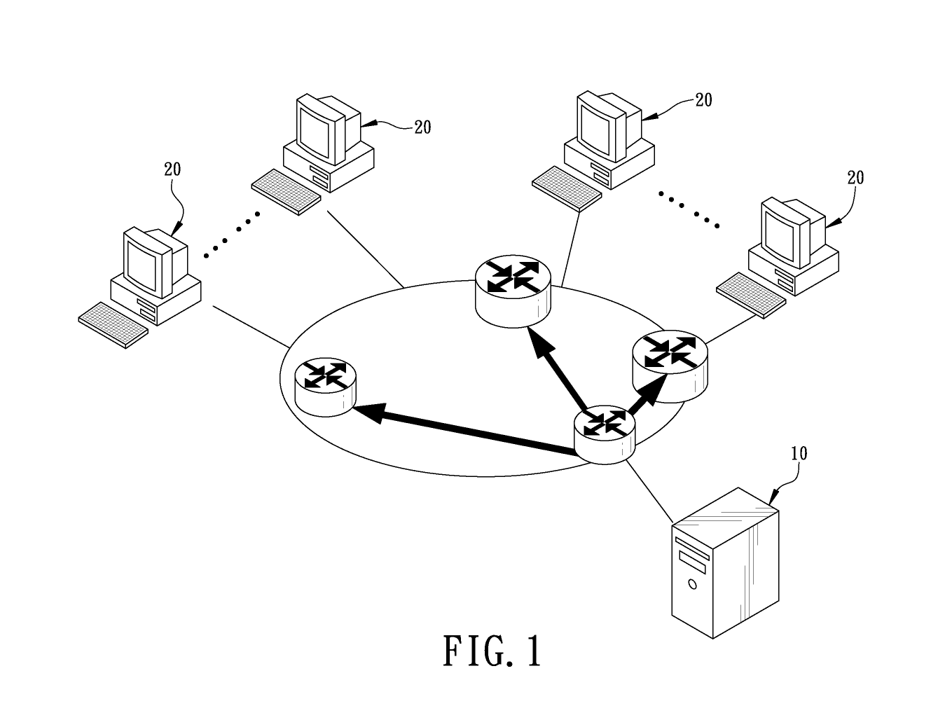

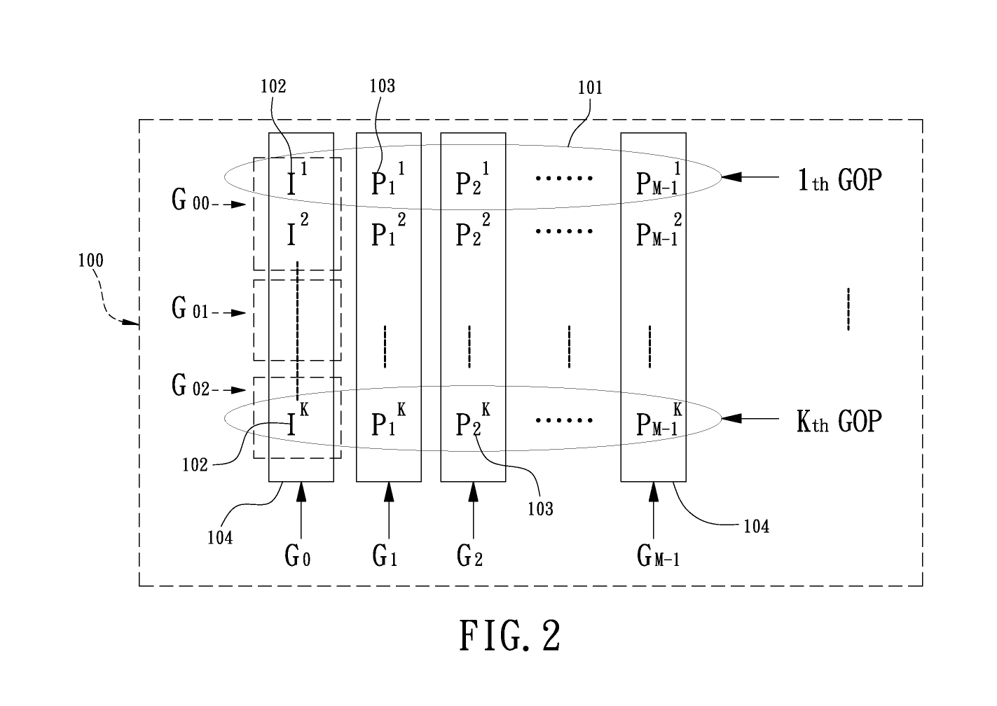

First, FIGS. 1 and 2 show schematic views of the present invention in a linking state and in a distributive state. The mechanism of interleaving video frame storage for P2P-based VOD streaming system comprises:

A server unit 10, namely a Video on Demand (VOD) server, saves at least one video 100 that has plural groups of pictures (GOP) 101. Each group of pictures 101 provides with an I frame 102 as well as a plurality of P frames 103. The number of the GOP 101 in the video 100 in the embodiment is K, and the number of the frames in each GOP 101 is M. Further, each GOP 101 further include one I frame 102 as well as the number of P frames 103 to (M−1). Herein, I^{L} represents the I frame 102, and PE represents the P frames 103. Therefore, the presentation is shown as L=1˜K, and E=1˜(M−1). Additionally, the GOP 101 further includes several B frames (not shown), and the I frame 102 as well as the P frame 103 in the video 100 would be alternately classified into several interleaved frame groups 104. Herein, Gᵢ represents each interleaved frame group 104, and i=0˜M. The interleaved frame groups 104 are sorted by a forming sequence of the I frame 102 and the P frames 103 in the GOP 101. Whereby, frame data with a same serial number in each GOP 101 could form the interleaved frame groups 104. A number of the interleaved frame groups 104 is equal to a total M of frames of the GOP 101. The interleaved frame groups 104 further include one I frame group G₀ and several P frame groups G_{1-M-1}. If an average data amount of the I frame group G₀ is n times as a data amount of each P frame group, the I frame group G₀ has to be classified into n I frame subgroups. Wherein, n is directed to an integer greater than zero. Moreover, G₀ₙ represents the I frame subgroups, and n=0˜2 in this embodiment.

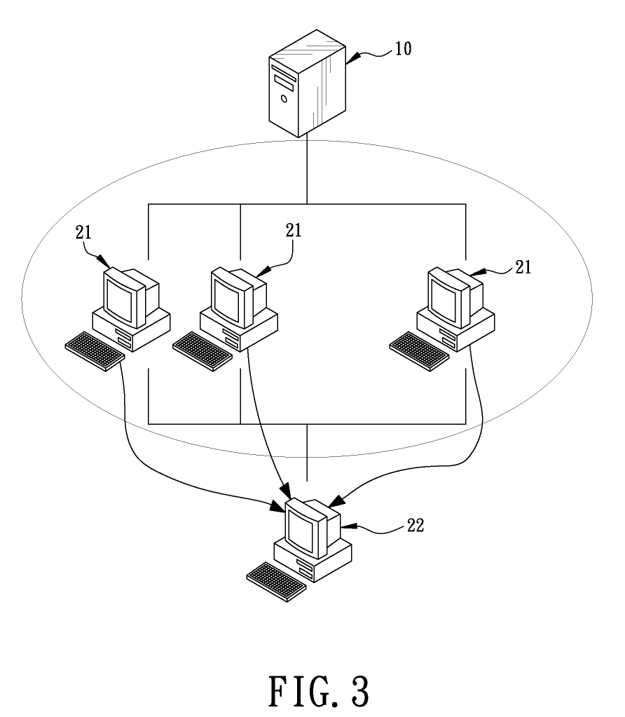

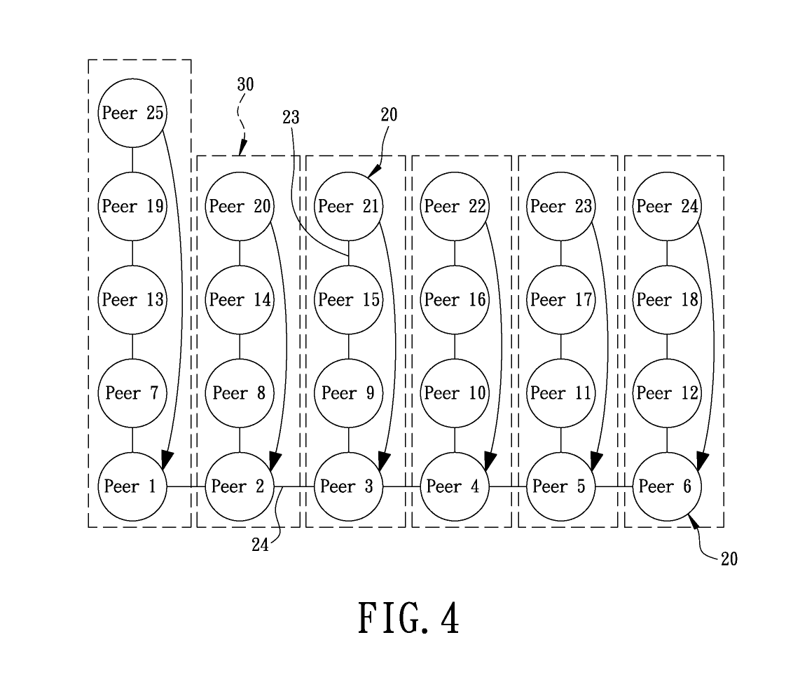

FIGS. 3 and 4 show the schematic views of the present invention with the interleaved frame groups being transmitted to peer nodes at a receiving end and an overlay structure of the present invention in a linking state. A plurality of peer nodes 20 connect to the server unit 10, and each peer node 20 could respectively save one interleaved frame group 104 in advance. Concurrently, each peer node 20 is set either at a supplying end (peer node 21) or at a receiving end (peer node 22). Each peer node 20 includes a prefetching buffer and a playback buffer. The prefetching buffer is set for storing the distributed interleaved frame groups 104. Wherein, the data saved in the prefetching buffer would not be cleared up until the user logins out the system in accordance with the present invention. In addition, the playback buffer is set for temporarily receiving the interleaved frame groups 104 that have not been played. Thereby, after finishing playing the received video 100, the data saved in the playback buffer would be deleted. If the peer nodes 20 store the same interleaved frame group 104, a linking member 23 is set for linking the peer nodes 20 with each other, thereby relatively defining an overlay structure 30. In the preferred embodiment, the peer nodes 20 (peer 4, peer 10, peer 16, peer 22) are saved in the same interleaved frame group 104, and the linking member 23 is applied to link these elements with each other. Moreover, the last peer node 20 in each overlay structure 30 has to be directed at the first peer node 20 in order to prevent the linking member 23 from an irreparable breakage. For achieving the purpose of swiftly finding a suited provider according to the extracting order of the GOP 101, a group linking member 24 is additionally set to link all of the first peer nodes 20 in the overlay structure 30.

Accordingly, the server unit 10 or each peer node 20 transmits the stored interleaved frame groups 104 to other peer nodes 20 in the system in accordance with the present invention according to groups of transmission rule each comprises at least one transmission rule. If the groups of transmission rule execute the directing when the peer nodes 22 at the receiving end are linked to the system in accordance with the present invention, the server unit 10 would record pieces of information from the peer nodes 22 at the receiving end. Thereby, the server unit 10 further executes a calculation and sets a distribution for showing the peer nodes at the receiving end with the needed prefetching interleaved frame groups 104. As a result, if the peer nodes 22 at the receiving end request to watch a video, the server unit 10 would inquire the allowable peer node 21 at the supplying end of the respective interleaved frame groups 104 of the video. Afterwards, the acquired information would be shown to the peer nodes 22 at the receiving end, from which an instant video request message would be provided to the peer nodes 21 at the supplying end; thereby, after receiving the message on request, the peer nodes 21 at the supplying end would streamingly transmit the interleaved frame groups 104 to the peer nodes 22 at the receiving end. However, if the peer nodes 21 at the supplying end are unable to offer the stored interleaved frame groups 104 to the peer nodes 22 at the receiving end, the server unit 10 would streamingly transmit the interleaved frame groups 104 to the peer nodes 22 at the receiving end. As a result, either one or multiple peer nodes 21 at the supplying end could concurrently provide the interleaved frame groups 104 for the peer nodes 22 at the receiving end.

I claim:

1. Mechanism of interleaving video frame storage for P2P-based VOD streaming system comprising:
a server unit including at least one video that has multiple groups of pictures (GOP); each group of pictures providing with an I frame as well as a plurality of P frames; wherein, said I frame and said P frames in said video being alternately classified into multiple interleaved frame groups; said interleaved frame groups being sorted by an arrangement of said I frame and said P frames in said groups of pictures, and said interleaved frame groups being formed by frame datas with a same serial number in each group of pictures; a number of said interleaved frame groups being equal to a total of frames of said groups of pictures; and
a plurality of peer nodes connecting to said server unit; each peer node respectively receiving said interleaved frame group in advance, each peer node being set either at a supplying end or at a receiving end;
whereby, said server unit or each peer node transmitting one stored interleaved frame group to other peer nodes in said system according to a group of transmission rule that comprises at least one transmission rule.

2. The mechanism of interleaving video frame storage for P2P-based VOD streaming system as claimed in claim 1, wherein, said group of transmission rules directs in a manner that said peer nodes at said receiving end link to said system; said server unit streamingly transmit said interleaved frame groups to said peer nodes at said receiving end in case that said peer nodes at said supplying end are unable to offer said stored interleaved frame groups to said peer nodes at said receiving end.

3. The mechanism of interleaving video frame storage for P2P-based VOD streaming system as claimed in claim 1, wherein, said group of transmission rules directs in a manner that said peer nodes at said receiving end link to said system, and said server unit records pieces of information of said peer nodes at said receiving end; said server unit further executes a calculation and a distribution for showing said peer nodes at said receiving end with needed prefetching groups of said interleaved frames and inquires said allowable interleaved frame group from said peer nodes for showing an inquired data to said peer nodes at said receiving end; said peer nodes at said receiving end instantly transmit a requested video message to said peer nodes at said supplying end, thereby said peer nodes at said supplying end streamingly transmit said interleaved frame groups to said peer nodes at said receiving end after said peer nodes at said supplying end receive said requested message.

4. The mechanism of interleaving video frame storage for P2P-based VOD streaming system as claimed in claim 1, wherein, each peer node includes a prefetching buffer and a playback buffer; said prefetching buffer is set for storing said distributed interleaved frame groups, and said playback buffer is set for temporarily receiving interleaved frame groups that have not been played.

5. The mechanism of interleaving video frame storage for P2P-based VOD streaming system as claimed in claim 1, wherein, if said peer nodes store the same interleaved frame groups, a linking member is set for linking said peer nodes with each other, thereby relatively defining an overlay structure.

6. The mechanism of interleaving video frame storage for P2P-based VOD streaming system as claimed in claim 1, wherein, said interleaved frame group further includes one I frame group and several P frame groups; an average data amount of said I frame group set by n times as a data amount of each P frame groups renders said I frame group to be classified into n I frame subgroups, Wherein, n is directed to an integer greater than zero.
